(19) United States
(12) Patent Application Publication
(10) Pub. No.: US 2026/0030484 A1
(43) Pub. Date: Jan. 29, 2026

(54) INFORMATION PROCESSING METHOD, INFORMATION PROCESSING SYSTEM, AND INFORMATION PROCESSING PROGRAM

(71) Applicant: Hitachi, Ltd., Tokyo (JP)

(72) Inventors: Hiroaki AKUTSU, Tokyo (JP); Takahiro NARUKO, Tokyo (JP)

(73) Assignee: Hitachi, Ltd., Tokyo (JP)

(21) Appl. No.: 19/223,514

(22) Filed: May 30, 2025

(30) Foreign Application Priority Data
Jul. 23, 2024 (JP) 2024-117648

(51) Int. Cl. G06N 3/0455

(52) U.S. Cl. CPC G06N 3/0455

(57) ABSTRACT

In an information processing method, an information processing system generates a feature of input data, and acquires retrieved data of the input data corresponding to the feature, based on correspondence relationship information between the feature and the retrieved data. The information processing system inputs the acquired retrieved data to a generation artificial intelligence (AI), and acquires answer data to the input data from the generation AI.

### BACKGROUND OF THE INVENTION

### 1. Field of the Invention

The present invention relates to an information processing method, an information processing system, and an information processing program.

### 2. Description of Related Art

In recent years, generation artificial intelligence (AI) such as large language models (LLM) has become widespread. The generation AI can improve accuracy of an answer by generating the answer based on input data based on a search result of external information related to a prompt describing a question of a user and the prompt.

When a data capacity used as external information is large, it is necessary to reduce the data capacity stored in a storage area. Therefore, in the related art disclosed in PTL 1, an image is compressed to a data capacity corresponding to importance of each area of the image, thereby reducing a data capacity of compressed data stored in a storage area.

### CITATION LIST

### Patent Literature

PTL 1: JP2022-145701A

### SUMMARY OF THE INVENTION

However, in the above-described related art, since intermediate representation data used when generating input data to be input to the generation AI is generated each time using a neural network, there is room for improvement in a processing speed of data generation using a generation AI.

The invention is made in view of the above problems, and an object of the invention is to improve a processing speed of data generation using a generation AI.

In order to achieve the above object, one aspect of the invention is an information processing method to be executed by an information processing system including a processor and a memory. The information processing method, by the processor, includes: receiving input data; generating a feature of the input data; acquiring retrieved data of the input data corresponding to the feature, based on correspondence relationship information between the feature and the retrieved data; inputting the acquired retrieved data to a generation artificial intelligence (AI); and acquiring answer data to the input data from the generation AI.

According to the invention, a processing speed of data generation using the generation AI can be improved, and a compression rate of data accumulated in a storage area can be improved.

### BRIEF DESCRIPTION OF THE DRAWINGS

FIG. 1 illustrates a configuration of a computer according to Embodiment 1;

FIGS. 2A and 2B are diagrams illustrating an outline of a data accumulation process and a data generation process in the computer according to Embodiment 1;

FIG. 3 illustrates a configuration of a retrieved data table according to Embodiment 1;

FIGS. 4A and 4B are diagrams illustrating an outline of a data accumulation process and a data generation process in a computer according to Embodiment 2;

FIG. 5 is a diagram illustrating an outline of a model training process in the computer according to Embodiment 2;

FIG. 6 is a flowchart illustrating the data accumulation process in the computer according to Embodiment 2;

FIG. 7 is a flowchart illustrating the data generation process in the computer according to Embodiment 2;

FIGS. 8A and 8B are diagrams illustrating an outline of a data accumulation process and a data generation process in a computer according to Embodiment 3;

FIG. 9 is a diagram illustrating an outline of a training process in the computer according to Embodiment 3;

FIG. 10 is a flowchart illustrating the data accumulation process according to Embodiment 3;

FIG. 11 is a flowchart illustrating the data generation process according to Embodiment 3;

FIG. 12 illustrates an outline of a neural network model according to Embodiment 4; and

FIG. 13 is a diagram illustrating an outline of Causal Linear according to Embodiment 4.

### DESCRIPTION OF EMBODIMENTS

In the following description, an “interface device” may be one or more interface devices. The one or more interface devices may be at least one of the following.
One or more input/output (I/O) interface devices. The input/output (I/O) interface device is an interface device for at least one of an I/O device and a remote display computer. The I/O interface device for the display computer may be a communication interface device. The at least one I/O device may be a user interface device, for example, an input device such as a keyboard and a pointing device, or an output device such as a display device.
One or more communication interface devices. The one or more communication interface devices may be one or more communication interface devices of the same type (for example, one or more network interface cards (NICs)) or two or more communication interface devices of different types (for example, an NIC and a host bus adapter (HBA)).

In the following description, a “memory” is one or more memory devices, and may typically be a main storage device. At least one memory device in the memory may be a volatile memory device or a non-volatile memory device.

In the following description, a “persistent storage device” is one or more persistent storage devices. The persistent storage device is typically a non-volatile storage device (for example, an auxiliary storage device), and is specifically, for example, a hard disk drive (HDD) or a solid state drive (SSD).

In the following description, a “storage device” may be a physical storage device such as a persistent storage device or a logical storage device associated with the physical storage device.

In the following description, a “processor” is one or more processor devices. At least one processor device is typically a microprocessor device such as a central processing unit (CPU), and may also be another type of processor device such as a graphics processing unit (GPU). At least one processor device may be a single core or a multi-core. At least one processor device may be a processor core. At least one processor device may be a processor device in a broad sense, such as a hardware circuit (for example, a field-programmable gate array (FPGA) or an application specific integrated circuit (ASIC)) that performs a part or all of processes.

In the following description, information from which an output is obtained with respect to an input may be described by an expression such as “xxx table”, but the information may be data of any structure or may be a training model such as a neural network that generates an output with respect to an input. Therefore, the “xxx table” can be referred to as “xxx information”. In the following description, a configuration of each table is an example. One table may be divided into two or more tables, or all or some of two or more tables may be one table.

In the following description, functions may be described using expressions “xxx-er” and “xxx unit”. The function may be implemented when one or more computer programs are executed by a processor, or may be implemented by one or more hardware circuits (for example, an FPGA or an ASIC). When a function is implemented by executing a program by a processor, the function may be at least a part of the processor as a specified process is executed using a storage device and/or an interface device as appropriate. The process described with a function as a subject may be a process performed by a processor or a device including the processor. The program may be installed from a program source. The program source may be, for example, a program distribution computer or a computer-readable recording medium (for example, a non-transitory recording medium). Description of functions is an example. A plurality of functions may be integrated into one function, or one function may be divided into a plurality of functions. In the following embodiments, image data may be either a still image or a video image.

### Embodiment 1

### Configuration of Computer 10 According to Embodiment 1

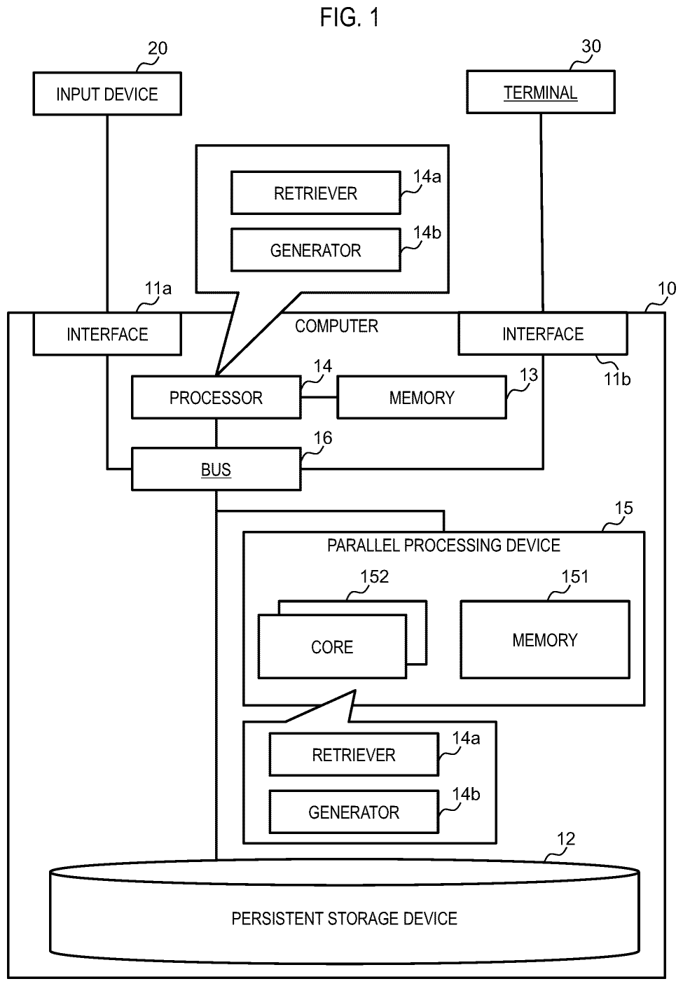

FIG. 1 is a diagram illustrating a configuration of the computer 10 according to Embodiment 1. The computer 10 is an example of an information processing system. A process of the computer 10 is executed by a processor 14 and a parallel processing device 15 to be described later. The computer 10 can process a plurality of batches in parallel. The computer 10 is a computer or a storage device in an on-premise environment or a cloud environment. An input device 20 is a computer in an on-premise environment or a cloud environment. The persistent storage device 12 may be a storage in an on-premise environment or a cloud environment communicably connected to the computer 10.

The computer 10 includes interfaces 11a and 11b (an example of an interface device), the persistent storage device 12, a memory 13, the processor 14, the parallel processing device 15, and a bus 16 that connects these components. The interfaces 11a and 11b, the persistent storage device 12, and the parallel processing device 15 are communicably connected to the processor 14 via, for example, the bus 16.

The interface 11a is connected to the input device 20. The input device 20 inputs data to the computer 10. The input device 20 may be a sensor device (for example, an optical camera or a gravity sensor), a portable storage medium, or another computer.

The interface 11b is connected to a terminal 30. The terminal 30 inputs a prompt to the computer 10 when a user makes an inquiry to a generation AI (not illustrated). The computer 10 generates an answer based on the prompt and outputs the answer to the terminal 30. A general computer can be used as the terminal 30.

Data to be compressed input from the input device 20 via the interface 11b is input to the parallel processing device 15 via or not via the processor 14. In the present embodiment, the data to be compressed is image data representing an image (still image), but any type of data may be used. The parallel processing device 15 includes a memory 151 and a plurality of cores 152.

The memory 13 stores a computer program executed by the processor 14 and data input and output by the processor 14.

The processor 14 executes at least a part of the process executed by the computer 10 by reading and executing the program from the memory 13. The processor 14 and the parallel processing device 15 are implemented as a retriever 14a and a generator 14b by executing the program. Details of processes of the retriever 14a and the generator 14b will be described later.

For example, a system may be implemented using a plurality of computers 10. When a system is implemented using a plurality of computers 10, some of the computers 10 including the persistent storage device 12 may be implemented as a storage system, and a storage system may be used as a storage medium for another computer 10 (the persistent storage device 12, the memory 13, or the like). In addition, by executing a part of a process described in the following embodiments by the parallel processing device 15, the processor 14, or the like of the computer 10 on a storage system side, efficiency may be improved by executing the process in an aggregation manner near a data storage destination.

### Outline of Data Accumulation Process and Data Generation Process According to Embodiment 1

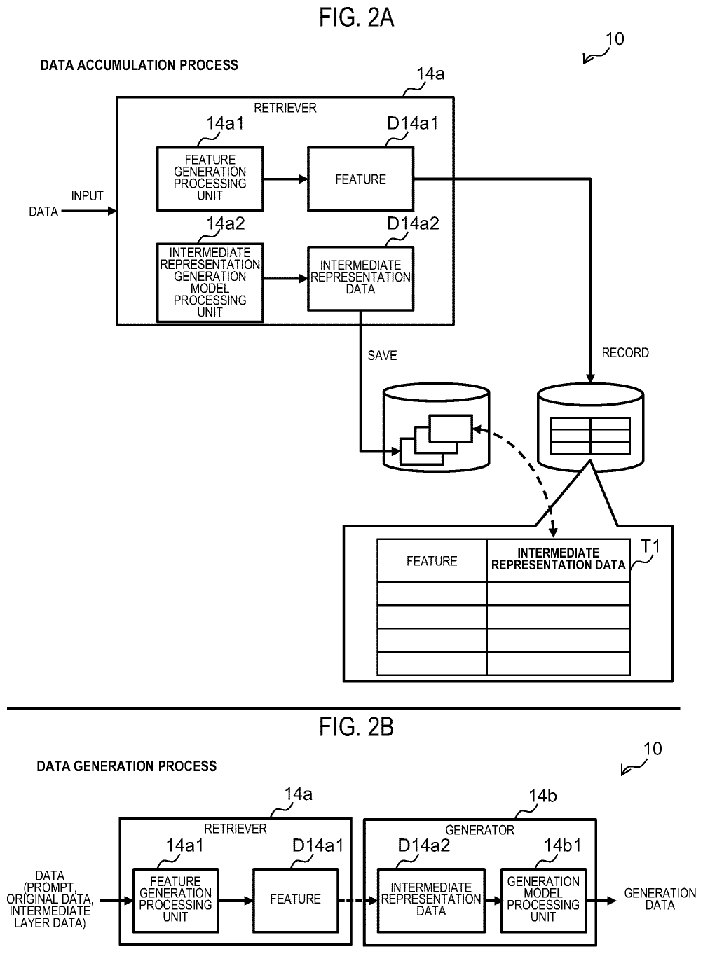

FIGS. 2A and 2B are diagrams illustrating the outline of the data accumulation process and the data generation process in the computer 10 according to Embodiment 1.

### Outline of Data Accumulation Process According to Embodiment 1

First, with reference to FIG. 2A, the data accumulation process in the retriever 14a according to Embodiment 1 will be described.

In the retriever 14a, a feature generation processing unit 14a1 generates a feature D14a1 based on original data (image data) input from the input device 20. An intermediate representation generation model processing unit 14a2 has an intermediate representation generation model, and uses the intermediate representation generation model to generate intermediate representation data D14a2 based on the image data input from the input device 20. The intermediate representation generation model that the intermediate representation generation model processing unit 14a2 has is, for example, a neural network model.

When stored in a retrieved data table T1, the feature D14a1 and the intermediate representation data D14a2 are compressed (entropy coded). The feature D14a1 and the intermediate representation data D14a2 of the compressed image data are associated with the same image data and recorded in the retrieved data table T1 stored in the memory 13, 151. The intermediate representation data D14a2 is saved in a storage area of a storage.

### Outline of Data Generation Process According to Embodiment 1

Next, with reference to FIG. 2B, the data generation process in the retriever 14a and the generator 14b according to Embodiment 1 will be described.

First, in the retriever 14a, the feature generation processing unit 14a1 receives original data (image data) or intermediate layer data, and generates the feature D14a1 based on the original data (image data) or the intermediate layer data.

Next, the retriever 14a (or the generator 14b) refers to the retrieved data table T1 based on the feature D14al, and acquires the corresponding intermediate representation data D14a2.

When the generation model processing unit 14b1 described below has an input layer, one or more intermediate layers, and an output layer, the feature generation processing unit 14a1 takes as input data the original data (image data) in the input layer, and as input data in the intermediate layer and output layer generation data by a previous input layer or intermediate layer (intermediate layer data).

Next, in the generator 14b, the generation model processing unit 14b1 refers to the retrieved data table T1 to acquire the intermediate representation data D14a2. Then, the generation model processing unit 14b1 inputs the acquired intermediate representation data D14a2, prompt, and intermediate layer data to a generation model (generation AI), and acquires generation data generated by the generation model (generation AI). The generation model processing unit 14b1 includes a generation model (generation AI) such as LLM, at least a part of which is implemented by a neural network model. If the generation data is an output of the intermediate layer of the generation model (generation AI), the generation data is the intermediate layer data that is an input of a next intermediate layer process, but if the generation data is an output of a final layer of the generation model (generation AI), the generation data is answer data for the generation model (generation AI).

The generation model processing unit 14b1 may be provided in another computer that is different from the computer 10 and can communicate with the computer 10 via a network, instead of the generator 14b.

### Configuration of Retrieved Data Table T1 According to Embodiment 1

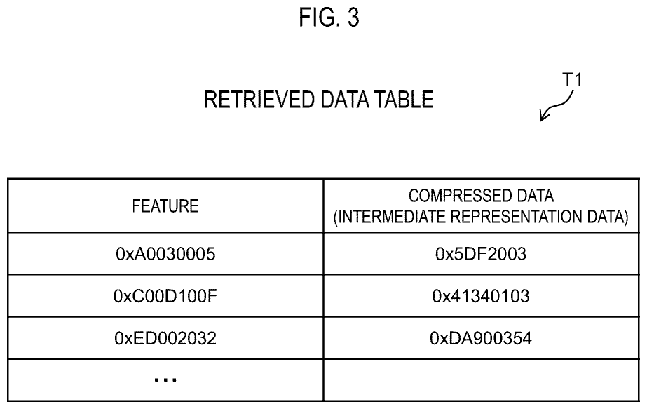

FIG. 3 is a diagram illustrating the configuration of the retrieved data table T1 according to Embodiment 1. The retrieved data table T1 is stored in the memory 13, 151. Cosine similarity may be used as similarity of the feature. In addition, in order to speed up determination of the similarity, locality sensitive hashing (LSH), determination whether there is a match based on a quantized value of the feature D14al, or the like may be used.

The retrieved data table T1 includes columns of “feature” and “compressed data (intermediate representation data)”. “Feature” is a feature of image data represented by a continuous natural number or the like. The intermediate representation data is compressed data obtained by compressing the original data. The image data of the original data typically has a size of C (number of channels) x N (length) (N is indefinite).

The retrieved data table T1 is a table for outputting “compressed data (intermediate representation data)” corresponding to the “feature” having the highest similarity to the input feature. The “compressed data (intermediate representation data)” may store, instead of the intermediate representation data, a pointer indicating a storage location in the storage that stores an entity of the intermediate representation data.

### Effects of Embodiment 1

In Embodiment 1, the retrieved data of the input data corresponding to the feature of input data is acquired from the retrieved data table or the like in which correspondence relationship information between the feature and retrieved data is stored, and input to the generation AI, and answer data to the input data is acquired from the generation AI. Therefore, according to Embodiment 1, since the retrieved data such as the intermediate representation data used when generating the input data to the generation AI is converted in advance, it is not necessary to generate the retrieved data each time, and thus it is possible to prevent a decrease in a processing speed of data generation.

### Embodiment 2

In Embodiment 2, differences from Embodiment 1 will be mainly described, and redundant description will be omitted.

### Outline of Data Accumulation Process and Data Generation Process According to Embodiment 2

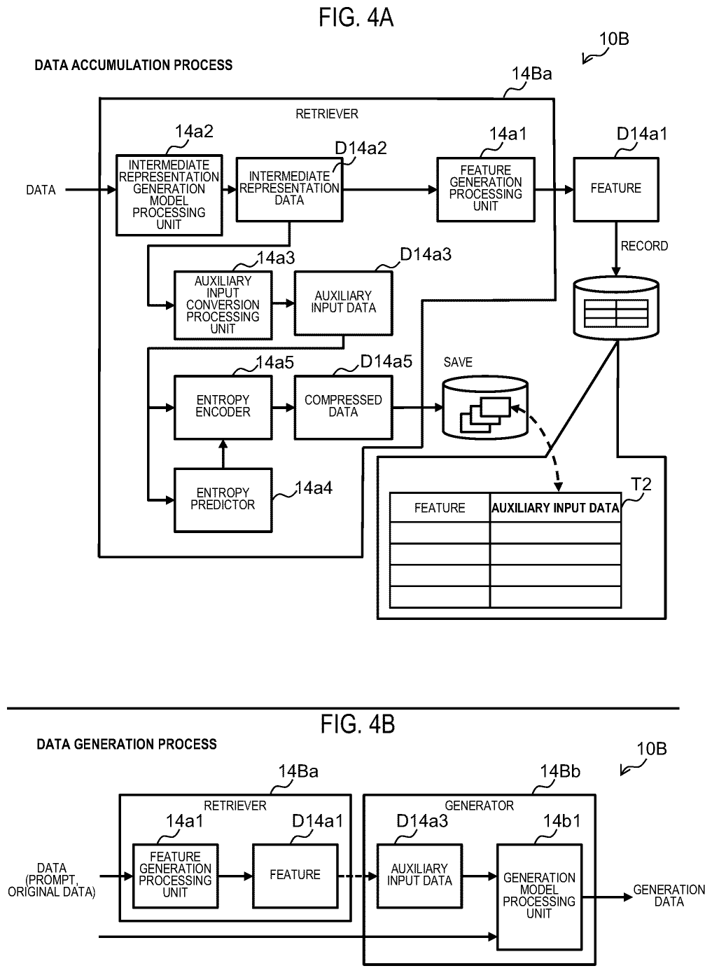

FIGS. 4A and 4B are diagrams illustrating the outline of the data accumulation process and the data generation process in a computer 10B according to Embodiment 2.

### Outline of Data Accumulation Process According to Embodiment 2

First, with reference to FIG. 4A, the data accumulation process in the retriever 14Ba according to Embodiment 2 will be described.

In the retriever 14Ba, the intermediate representation generation model processing unit 14a2 generates the intermediate representation data D14a2 based on original data (image data) input from the input device 20. The feature generation processing unit 14a1 has an intermediate representation generation model, and uses the intermediate representation generation model to generate the feature D14a1 based on the intermediate representation data D14a2 generated by the intermediate representation generation model processing unit 14a2. The intermediate representation generation model that the feature generation processing unit 14a1 has is, for example, a neural network model.

Meanwhile, an auxiliary input conversion processing unit 14a3 converts the intermediate representation data D14a2 generated by the intermediate representation generation model processing unit 14a2 to generate auxiliary input data D14a3. The auxiliary input data D14a3 is data input to the generation model (generation AI) of the generation model processing unit 14b1 together with a prompt such that the generation data generated by the generation model (generation AI) has high accuracy as answer data.

An entropy predictor 14a4 predicts a probability distribution f of each symbol, which is a data unit of compression, for the auxiliary input data D14a3 using prediction based on an autoregressive model or the like. Then, the entropy predictor 14a4 calculates a cumulative distribution function (CDF) of the probability distribution f. The probability distribution f and the cumulative distribution function CDF for each symbol are referred to as a predicted probability (CDF, f) of each symbol.

The entropy encoder 14a5 encodes each symbol based on each symbol based on the auxiliary input data D14a3 and the predicted probability (CDF, f) of each symbol from the entropy predictor 14a4, and outputs compressed data D14a5. The compressed data D14a5 is saved in the storage area of the storage.

The feature D14a1 is compressed (entropy coded) when recorded in a retrieved data table T2. The feature D14a1 and the auxiliary input data D14a3 of the compressed image data are associated with the same image data and recorded in the retrieved data table T2 stored in the memory 13, 151. In the retrieved data table T2, “compressed data (intermediate representation data)” in the retrieved data table T1 is replaced with “compressed data (auxiliary input data)”. The auxiliary input data is saved in the storage area of the storage.

### Outline of Data Generation Process According to Embodiment 2

Next, the data generation process in the computer 10B according to Embodiment 2 will be described with reference to FIG. 4B.

First, in the retriever 14Ba, the feature generation processing unit 14a1 generates the feature D14a1 based on input data (a prompt or the like input to a generation model that the generation model processing unit 14b1 has).

Next, the retriever 14Ba (or a generator 14Bb) refers to the retrieved data table T2 based on the feature D14a1 and acquires the corresponding auxiliary input data D14a3.

Next, in the generator 14Bb, the generation model processing unit 14b1 inputs the auxiliary input data D14a3 and the prompt acquired by referring to the retrieved data table T2 to the generation model (generation AI). The generation model processing unit 14b1 acquires the generation data (answer data) generated by the generation model (generation AI).

### Outline of Model Training Process According to Embodiment 2

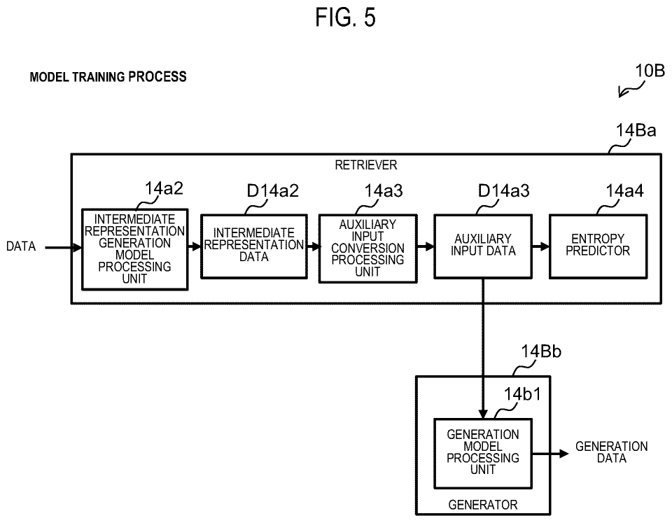

FIG. 5 is a diagram illustrating an outline of the model training process in the computer 10B according to Embodiment 2.

In the retriever 14Ba, the intermediate representation generation model processing unit 14a2 generates the intermediate representation data D14a2 based on input original data (image data). The auxiliary input conversion processing unit 14a3 converts the intermediate representation data D14a2 generated by the intermediate representation generation model processing unit 14a2 into the auxiliary input data D14a3.

The entropy predictor 14a4 and the generation model processing unit 14b1 of the generator 14Bb trains the intermediate representation data D14a2 by back propagation. By the training, the generation model processing unit 14b1 generates or updates the generation model (generation AI) that the generation model processing unit 14b1 has.

### Data Accumulation Process According to Embodiment 2

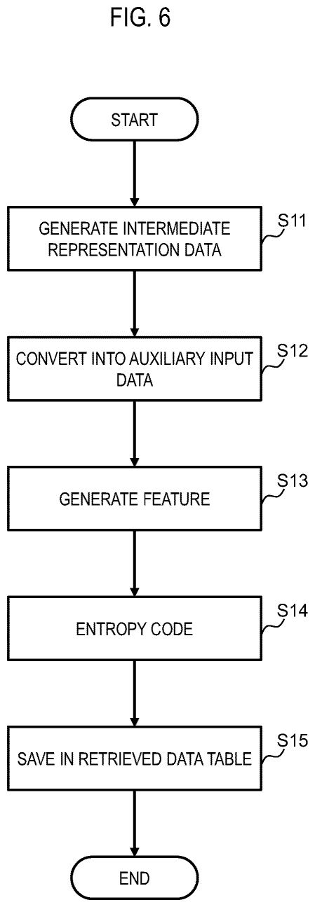

FIG. 6 is a flowchart illustrating the data accumulation process in the computer 10B according to Embodiment 2. The data accumulation process corresponds to FIG. 4A. In the data accumulation process, steps S11 to S15 are executed for each piece of input image data.

First, in step S11, the intermediate representation generation model processing unit 14a2 of the retriever 14Ba generates the intermediate representation data D14a2. Next, in step S12, the auxiliary input conversion processing unit 14a3 of the retriever 14Ba converts the intermediate representation data D14a2 generated in step S11 into the auxiliary input data D14a3.

Next, in step S13, the feature generation processing unit 14a1 of the retriever 14Ba generates the feature D14a1 based on the intermediate representation data D14a2 generated in step S11. Next, in step S14, the entropy encoder 14a5 of the retriever 14Ba encodes (compresses) the auxiliary input data D14a3 converted in step S12 to generate the compressed data D14a5. Next, in step S15, the retriever 14B stores the feature D14a1 generated in step S13 and the compressed data D14a5 compressed in step S14 in the retrieved data table T2 in association with each other.

### Data Generation Process According to Embodiment 2

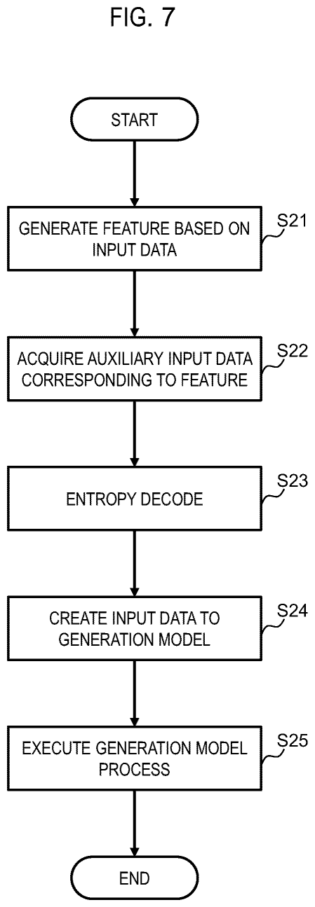

FIG. 7 is a flowchart illustrating the data generation process in the computer 10B according to Embodiment 2. The data generation process corresponds to FIG. 4B.

First, in step S21, the feature generation processing unit 14a1 of the retriever 14Ba generates the feature D14a1 for input data (a prompt or the like input to a generation model that the generation model processing unit 14b1 has) based on the input data. Next, in step S22, the retriever 14Ba (or the generator 14Bb) refers to the retrieved data table T2 based on the feature D14a1 generated in step S21, and acquires the corresponding auxiliary input data D14a3.

Next, in step S23, the retriever 14Ba (or the generator 14Bb) entropy decodes the auxiliary input data D14a3 acquired in step S22. Next, in step S24, the generator 14Bb creates input data to the generation model (generation AI) based on the auxiliary input data D14a3 entropy decoded in step S23 and a prompt input by a user.

Next, in step S25, the generation model processing unit 14b1 of the generator 14Bb inputs the input data created in step S24 to its own generation model (generation AI), and acquires answer data generated by the generation model (generation AI).

Embodiment 2 described above is suitable for an on-demand process of video data or the like.

### Effects of Embodiment 2

In Embodiment 2, a prompt for asking a question to the generation AI is used as the input data, and compressed data of the auxiliary input data based on the input data is used as retrieved data. Then, intermediate representation data is generated based on the prompt input to the generation AI, a feature is generated based on the intermediate representation data, the intermediate representation data is converted into auxiliary input data, and correspondence relationship information is generated by associating the feature with the auxiliary input data. Therefore, according to Embodiment 2, when the generation AI is used, the auxiliary input data is compressed and accumulated when data is accumulated, so that a data capacity accumulated in the storage area can be reduced.

In Embodiment 2, the intermediate representation data is generated based on a prompt for asking questions to the generation AI, the intermediate representation data is converted into the auxiliary input data, and the auxiliary input data is trained to generate a generation model that the generation AI has. Therefore, according to Embodiment 2, since the generation model is trained using the auxiliary input data, the generation model can be made compact.

In Embodiment 2, the auxiliary input data is trained to generate an entropy predictor corresponding to the intermediate representation data, the auxiliary input data is compressed using the entropy predictor, and the feature and the compressed auxiliary input data are associated with each other to generate correspondence relationship information (retrieved data table). Therefore, according to Embodiment 2, a data capacity of the retrieved data table can be reduced.

In Embodiment 2, the feature and the intermediate representation data are generated using a neural network model. Therefore, according to Embodiment 2, by calculating the correspondence relationship information between the feature and the auxiliary input data in advance and acquiring the auxiliary input data based on the correspondence relationship information based on the feature, it is not necessary to generate the intermediate representation data each time to calculate the auxiliary input data. Therefore, an effect of preventing a decrease in a processing speed of data generation becomes more remarkable.

### Embodiment 3

In Embodiment 3, differences from Embodiments 1 and 2 will be mainly described, and redundant description will be omitted.

### Outline of Data Accumulation Process and Data Generation Process in Computer 10C According to Embodiment 3

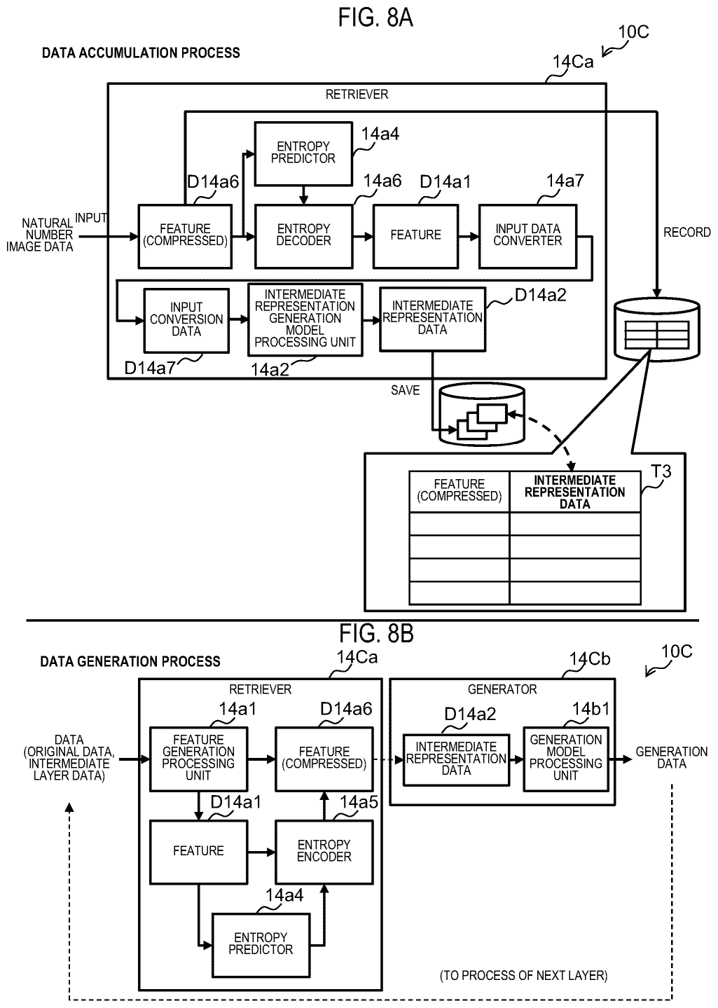

FIGS. 8A and 8B are diagrams illustrating the outline of the data accumulation process and the data generation process in the computer 10C according to Embodiment 3.

### Outline of Data Accumulation Process According to Embodiment 3

First, with reference to FIG. 8A, the data accumulation process in the computer 10C according to Embodiment 3 will be described. The data accumulation process is executed for all natural numbers represented by k bits.

A retriever 14Ca receives an input of a k-bit natural number N, which is the number of symbols for entropy coding, and image data. The retriever 14Ca generates a feature (compressed) D14a6 of the image data based on the image data.

The entropy predictor 14a4 predicts the predicted probability (CDF, f) of each symbol, which is a data unit of compression, based on the natural number N and the feature (compressed) D14a6.

An entropy decoder 14a6 decompresses the feature (compressed) D14a6 based on the predicted probability (CDF, f) of each symbol by the entropy predictor 14a4, and acquires the feature D14a1.

An input data converter 14a7 converts the feature D14a1 decompressed by the entropy decoder 14a6 into input conversion data D14a7, which is an input format of the intermediate representation generation model processing unit 14a2.

The intermediate representation generation model processing unit 14a2 has the intermediate representation generation model, and uses the intermediate representation generation model to generate the intermediate representation data D14a2 based on the input conversion data D14a7 input from the input data converter 14a7. The intermediate representation generation model that the intermediate representation generation model processing unit 14a2 has is, for example, a neural network model.

When stored in a retrieved data table T3, the intermediate representation data D14a2 may be compressed (entropy coded). The feature (compressed) D14a6 and the intermediate representation data D14a2 are associated with each other and recorded in the retrieved data table T3 stored in the memory 13, 151. In the retrieved data table T3, the “feature” in the retrieved data table T1 is replaced with the “feature (compressed)”. The intermediate representation data D14a2 is saved in the storage area of the storage.

### Outline of Data Generation Process According to Embodiment 3

Next, the data generation process in the computer 10C according to Embodiment 3 will be described with reference to in FIG. 8B.

The feature generation processing unit 14a1 uses the original data (image data) or the intermediate layer data as input data, and generates the feature (compressed) D14a6 based on the original data (image data) or the intermediate layer data.

The entropy predictor 14a4 predicts the predicted probability (CDF, f) of each symbol, which is a data unit of compression, for the feature D14a1 using prediction based on an autoregressive model or the like. The entropy encoder 14a5 encodes each symbol based on the symbol based on the feature D14a1 and the predicted probability (CDF, f) of each symbol from the entropy predictor 14a4, and outputs the feature (compressed) D14a6 obtained by compressing the feature D14al.

Next, the retriever 14Ca (or the generator 14Cb) refers to the retrieved data table T3 based on the feature (compressed) D14a6, and acquires the corresponding intermediate representation data D14a2.

Next, in the generator 14Cb, the generation model processing unit 14b1 inputs the intermediate representation data D14a2 and a prompt acquired by referring to the retrieved data table T3 to the generation model (generation AI). The generation model processing unit 14b1 acquires the generation data (intermediate layer data of a next layer or answer data) generated by the generation model (generation AI). At this time, the generation model processing unit 14b1 calculates a part of a matrix or the like of the neural model in the generation model (generation AI).

### Outline of Model Training Process According to Embodiment 3

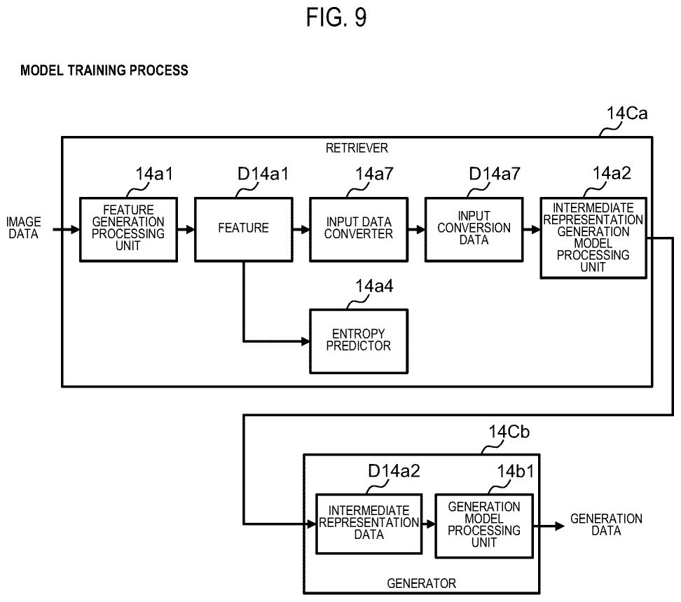

FIG. 9 is a diagram illustrating the outline of the model training process in the computer 10C according to Embodiment 3.

The feature generation processing unit 14a1 generates the feature D14a1 based on input data (image data). The input data converter 14a7 converts the feature D14a1 into the input conversion data D14a7. The intermediate representation generation model processing unit 14a2 generates the intermediate representation data D14a2 using the input conversion data D14a7 as an input.

The entropy predictor 14a4 of the retriever 14Ca and the generation model processing unit 14b1 of the generator 14Cb train the feature D14a1 and the intermediate representation data D14a2 by back propagation, respectively. By the training, the generation model processing unit 14b1 generates or updates the generation model (generation AI) that the generation model processing unit 14b1 has.

### Data Accumulation Process According to Embodiment 3

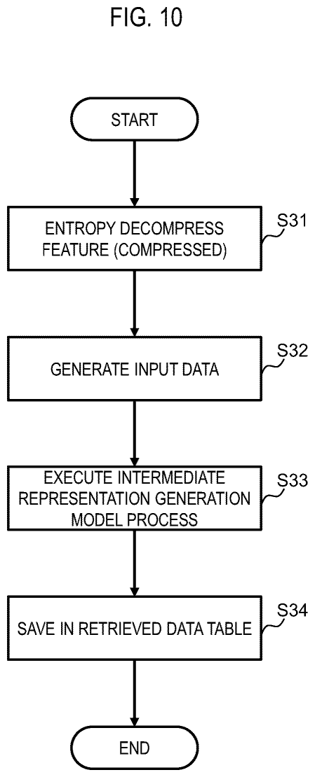

FIG. 10 is a flowchart illustrating the data accumulation process according to Embodiment 3. The data accumulation process corresponds to FIG. 8A. The data accumulation process is executed for all natural numbers represented by k bits. In the data accumulation process, steps S31 to S14 are executed for each input feature (compressed).

First, in step S31, the entropy decoder 14a6 of the retriever 14Ca decompresses the feature (compressed) D14a6 to generate the feature D14al. Next, in step S22, the input data converter 14a7 converts the feature D14a1 generated in step S31 into the input conversion data D14a7.

Next, in step S33, the intermediate representation generation model processing unit 14a2 of the retriever 14Ba receives the input conversion data D14a7 generated in step S32 and generates the intermediate representation data D14a2 thereof. Next, in step S34, the retriever 14B stores the input feature (compressed) D14a6 and the intermediate representation data D14a2 generated in step S33 in the retrieved data table T3 in association with each other.

### Data Generation Process According to Embodiment 3

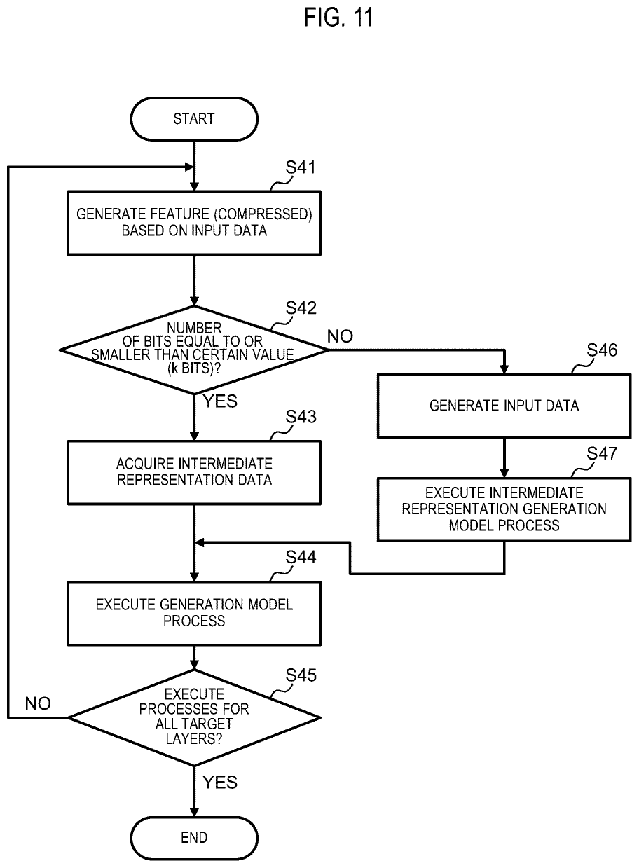

FIG. 11 is a flowchart illustrating the data generation process in the computer 10C according to Embodiment 3. The data generation process corresponds to FIG. 8B. Steps S41 to S45 of the data generation process are executed for each of layers, namely, an input layer, one or more intermediate layers, and an output layer, of the generation model processing unit 14b1.

First, in step S41, the feature generation processing unit 14a1 of the retriever 14Ca, together with the entropy predictor 14a4 and the entropy encoder 14a5, generates the feature (compressed) D14a6 of original image data (image data), which is input data, based on the image data. In step S41, in the input layer, original data (image data) is used as input data, and in the intermediate layer or the output layer, generation data by the previous input layer or intermediate layer (intermediate layer data) is used as input data.

Next, in step S42, the retriever 14Ba determines whether the feature (compressed) D14a6 generated in step S41 is equal to or smaller than a predetermined value (k bits). If the feature (compressed) D14a6 is equal to or smaller than the predetermined number of bits (YES in step S42), the retriever 14Ba moves the process to step S43, and if the feature (compressed) D14a6 is larger than the predetermined value (NO in step S42), the retriever 14Ba moves the process to step S46.

In step S43, the feature generation processing unit 14a1 refers to the retrieved data table T3 to acquire the intermediate representation data D14a2 corresponding to the feature (compressed) D14a6.

Next, in step S44, the generation model processing unit 14b1 of the generator 14Cb inputs the intermediate representation data D14a2 acquired in step S43 to the generation model that the generation model processing unit 14bl has to generate generation data. Next, in step S45, the retriever 14Ca (or the generator 14Cb) determines whether processes for all target layers (the input layer, the intermediate layer, and the output layer) is executed. If the processes for all the target layers are executed (YES in step S45), the retriever 14Ca (or the generator 14Cb) ends the data generation process. Meanwhile, the retriever 14Ca (or the generator 14Cb) returns the process to step S41 if there is a layer for which the process is not executed (NO in step S45).

In step S46, the input data converter 14a7 of the retriever 14Ca converts the feature D14a1 decompressed by the entropy decoder 14a6 into the input conversion data D14a7. Next, in step S47, the intermediate representation generation model processing unit 14a2 of the retriever 14Ca generates the intermediate representation data D14a2 based on the input conversion data D14a7 converted in step S46. When step S47 ends, the process proceeds to step S44.

In the data generation process illustrated in FIG. 11, if a size of the feature (compressed) D14a6 is equal to or smaller than k bits, the intermediate representation data D14a2 is acquired by referring to the retrieved data table T3. At this time, a high-speed memory of the memory 13, 151 may be used. Meanwhile, if the size of the feature (compressed) D14a6 generated in step S41 is larger than k bits, the intermediate representation data D14a2 is generated by the intermediate representation generation model processing unit 14b2.

For efficient use of the memory 13, 151, the persistent storage device 12 may be used as a work memory if the size of the feature (compressed) D14a6 is larger than k bits, and the memory 13, 151 may be used as a work memory if the size of the feature (compressed) D14a6 is equal to or smaller than k bits.

Embodiment 3 described above is suitable for a batch process of accumulated data.

### Effects of Embodiment 3

In Embodiment 3, image data for asking a question to the generation AI is used as input data, and compressed data of the intermediate representation data based on the image data is used as retrieved data. Then, the feature is generated based on the image data input to the generation AI, the feature (compressed) is generated based on the feature, and the feature (compressed) and the intermediate representation data are associated with each other to generate a correspondence relationship information. Therefore, according to Embodiment 3, when the generation AI is used, the intermediate representation data is compressed and accumulated when data is accumulated, so that a data capacity accumulated in the storage area can be reduced.

In Embodiment 3, a feature is generated based on image data, the feature is converted into input conversion data, intermediate representation data is generated based on the input conversion data, and a generation model that the generation AI has is generated by training the intermediate representation data. Therefore, according to Embodiment 3, since the generation model is trained using the intermediate representation data, the generation model can be made compact.

In Embodiment 3, the entropy predictor corresponding to the feature is generated by training the feature. Then, the feature is compressed using the entropy predictor, the feature (compressed) is decompressed, and the feature (compressed) and the compressed data of the intermediate representation data are associated with each other to generate correspondence relationship information (retrieved data table). Therefore, according to Embodiment 3, the data capacity of the retrieved data table can be reduced.

In Embodiment 3, the feature and the intermediate representation data are generated using a neural network model. Therefore, according to Embodiment 3, by calculating the correspondence relationship information between the feature (compressed) and the intermediate representation data in advance and acquiring the intermediate representation data based on the correspondence relationship information based on the feature (compressed), it is not necessary to generate the intermediate representation data each time. Therefore, the effect of preventing a decrease in the processing speed of the data generation becomes more remarkable.

In Embodiment 3, according to the feature (compressed) size, a process is switched between generating the intermediate representation data to be input to the intermediate layer of the generation model and inputting the intermediate representation data to the generation model or generating input data to be input to the generation model and inputting the input data to the generation model. Therefore, according to Embodiment 3, if the feature (compressed) is smaller than or equal to a threshold, the intermediate representation data is acquired by referring to the retrieved data table. Meanwhile, if the feature (compressed) exceeds the threshold and a certain amount is collected, intermediate representation data is generated using the neural network. In this way, it is possible to achieve both improvement of a processing speed of the data generation and prevention of deterioration of quality accuracy of the generation data. In addition, since only matching of values of the feature (compressed) is checked at the time of retrieving, comparison with a plurality of values based on cosine similarity or the like is not necessary, and a retrieving process can be speeded up. Since a method using a feature (compressed) uses a value after entropy coding, it is considered that a density of a space as the feature is higher than that of a method using LSH or a value obtained by quantizing the feature, and more data may be efficiently indexed.

### Embodiment 4

In Embodiment 4, differences from Embodiments 1, 2, and 3 will be mainly described, and redundant description will be omitted. In Embodiment 4, a configuration and a process of a neural network model as a specific implementation form of the feature generation processing unit 14al, the intermediate representation generation model processing unit 14a2, the auxiliary input conversion processing unit 14a3, the entropy predictor 14a4, the input data converter 14a7, the generation model processing unit 14b1, and the like described in Embodiment 1, 2, and 3 will be described.

### Outline of Neural Network Model According to Embodiment 4

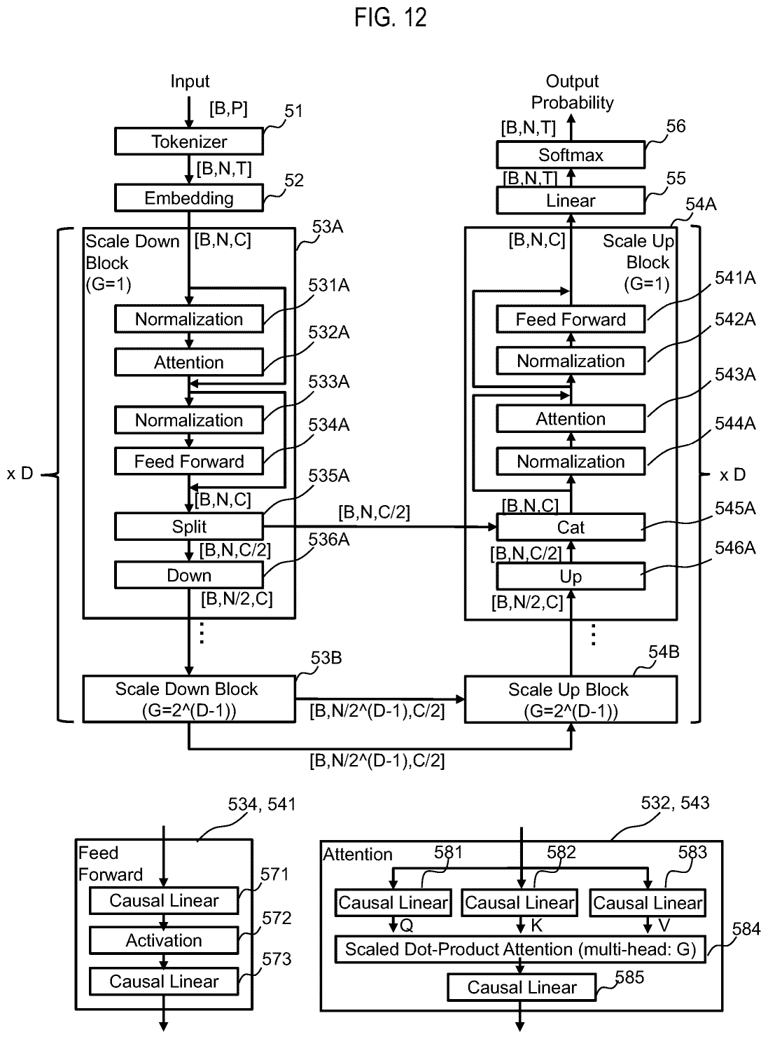

FIG. 12 illustrates an implementation example of the neural network model in the feature generation processing unit 14a1, the intermediate representation generation model processing unit 14a2, the auxiliary input conversion processing unit 14a3, the entropy predictor 14a4, the input data converter 14a7, the generation model processing unit 14b1, and the like described in Embodiments 1, 2, and 3. Tokenizer 51 is a process of tokenizing character string data, and receives input data [B, P] (hereinafter, for example, when written as [X, Y, Z], the [X, Y, Z] represents a tensor of a rank 3 and a shape of X, Y, and Z. A data format before and after the process is written in a similar notation in the figure) and outputs a one-hot vector of [B, N, T], wherein B represents the number of batches, P represents the number of input characters, N represents the number of tokens, and T represents the number of types of tokens. Embedding 52 is a process of converting the tokenized data into tensor data having an appropriate size in the subsequent process, and takes [B, N, T] as an input and [B, N, C] as an output, wherein C is a channel size (also referred to as a hidden dimension size). In this example, a case where the input data is a character string is described, and for example, when image data is input, the tokenizer 51 and the embedding 52 may be replaced with a process of patching in a token format by a convolution process.

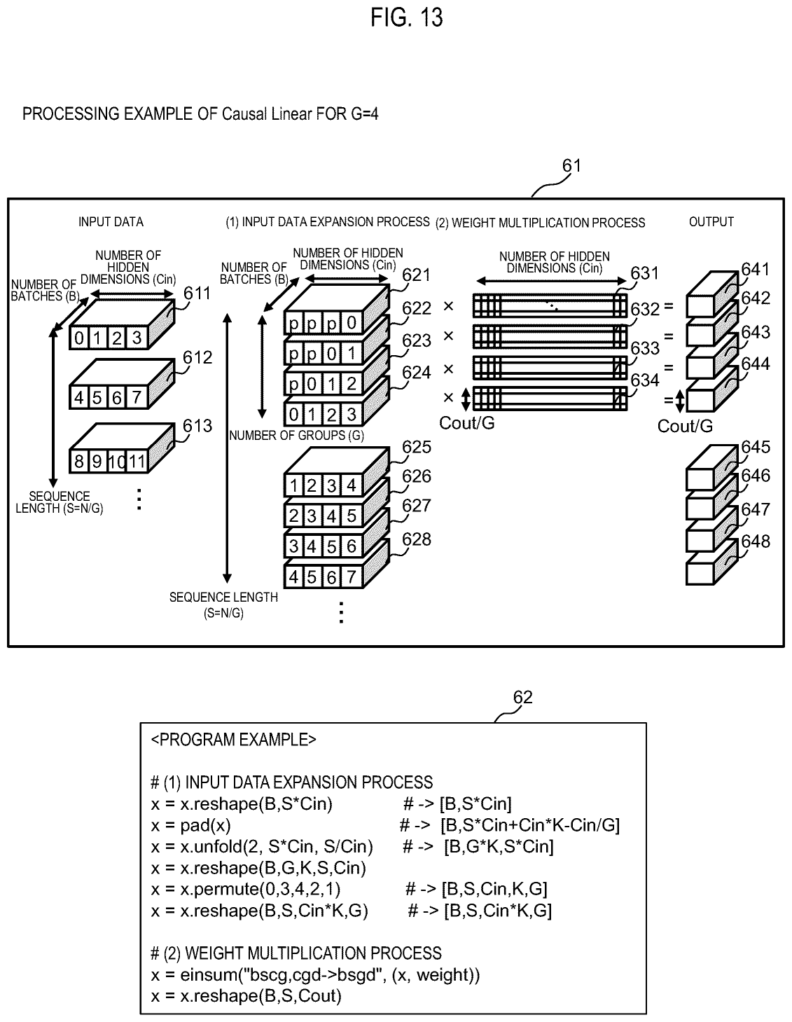

Next, Scale Down Block 53 (53A, 53B) is a processing block that receives [B, N, C] and outputs [B, N/2, C]. A plurality of (D pieces in the figure) Scale Down Blocks 53 may be connected to each other. When D pieces are connected, the final output is [B, N/2\hat{ }(D−1), C], wherein the number of groups G exists for each block. G may be G=2\hat{ }(D−1). G represents the number of groups in a channel dimension in the input data of the block, and in each block, processes may be independently performed in the number of groups G in the channel dimension. This will be described more specifically with reference to FIG. 13.

The Scale Down Block 53 includes a plurality of processes (processes from Normalization 531 to Down 536). The Normalization 531 and Normalization 533 are processes for normalizing inputs. Normalization may be performed in a channel direction. The channel may be divided by the number of groups G in the block, and normalization may be performed for each divided group of the channels. Attention 532 executes a self-attention process on the data. In the self-attention, data Q, data K, and data V may be output by three Causal Linear 581, 582, 583, the data Q, the data K, and the data V may be processed by a Scaled Dot-Product Attention 584 of a multi-head having a head of the number of groups G, and a result thereof may be processed by Causal Linear 585. In addition, when a target process is a decoder (for example, when used as the entropy predictor 14a4 or the generation model processing unit 14b1), in order to execute a prediction process, a mask may be applied to attention, and only past data may be referred to in a direction of a token sequence. Feed Forward 534 is a process including, for example, two Causal Linear 571 and 573 and an activation function 572.

As illustrated in FIG. 12, each of the above-described processes may be a residual network by inserting a data path that bypasses the process. Split 535 is a short-cut path from the Scale Down Block 53 (for example, 53A) to corresponding Scale Up Block 54 (for example, 54A), splits the input data in half in the channel dimension, and sends the split input data to the corresponding Scale Up Block 54. This short-cut path has an effect similar to that of the residual network, and when data granularity (token direction) is coarsened by the Scale Down Block 53, information with fine granularity of data is retained, and the process proceeds, thereby improving accuracy of the neural network as a whole, wherein when G is larger than 1, each group in the channel dimension may be divided in half, and a process may be performed so as to maintain a relationship of the number of groups. Next, in Down 536, for example, [B, N, C/2] may be input, and [B, N/2, C] may be output by converting two pieces of data adjacent in a token dimension in the channel direction.

Next, the Scale Up Block 54 (54A, 54B) is a processing block that receives [B, N/2, C] and outputs [B, N, C]. Hereinafter, a difference from the Scale Down Block 53 will be mainly described. First, Up 546 is a process opposite to the Down 536, and for example, [B, N/2, C] may be input, and [B, N, C/2] may be output by converting two pieces of data of the same group in the channel direction into a token dimension. Cat 545 is a process of connecting data received from the corresponding Scale Down Block 53 in the channel direction.

Linear 55 is a layer obtained by linear matrix operations using [B, N, C] as an input and [B, N, T] as an output. Softmax 56 calculates Softmax using [B, N, T] as an input, and outputs [B, N, T] as an appearance probability of each token, wherein in a case of an encoder, the Softmax 56 is unnecessary, and an output size of the Linear 55 may be changed as appropriate.

In the configuration of the neural network described above, by appropriately inserting the Scale Down Block 53 excluding the Split 535 and the Down 536, accuracy may be improved by creating a model having more parameters.

In a case of an encoder (for example, when used as the feature generation processing unit 14al, the intermediate representation generation model processing unit 14a2, the auxiliary input conversion processing unit 14a3, or the input data converter 14a7), output data may be quantized. A purpose of the quantization may be to execute the process in the entropy encoder 14a5 or the entropy predictor 14a4 thereafter or to reduce an amount of data. In addition, a neural network may be inserted before and after the encoder for the purpose of using a pre-trained model or reducing the amount of data.

### Outline of Causal Linear According to Embodiment 4

FIG. 13 illustrates an implementation example of a Causal Linear 61 (571, 573, 581, 582, 583, 585 in FIG. 12), which is a part of components of the neural network in FIG. 12. A processing example in this figure describes an example in which the number of groups G is 4.

In the example in FIG. 13, the Causal Linear 61 receives [B, S, Cin] and outputs [B, S, Cout]. A hidden dimension of the input data is divided into G and managed as indicated by numbers in the figure (for example, in a case of data 611, 0, 1, 2, 3 are identifiers indicating groups corresponding to a length N of a token dimension). In the Causal Linear 61, first (1) an input data expansion process is executed. By this process, each piece of data (such as 611, 612, 613) in a dimension of a sequence is duplicated to G number of groups while shifting the sequence by a fixed length.

For example, the data 611 at the beginning of the sequence is duplicated to G number of groups (data 621, 622, 623, 624) while being shifted using padding “p” as illustrated in FIG. 13. This duplication may be implemented by copying in a memory, or may be implemented by duplicating only references, thereby reducing a memory usage and memory transfer volume. Next, the Causal Linear 61 executes (2) a weight multiplication process. A matrix product operation is executed on the divided data (for example, 621, 622, 623, 624) with weights divided by the number of groups (for example, data 631, 632, 633, 634). As a result, outputs divided for each group are obtained and combined to obtain a final output. The Causal Linear 61 may execute a bias process (for example, a process of adding a weight) on the output.

FIG. 13 illustrates a pseudo program example 62 in PyTorch (registered trademark) style as an example of a more specific implementation method of the Causal Linear 61. A shape of processed data is illustrated as a comment on a right side of each row.

In the configuration described above, when padding is executed before the process of Up 546A even in a case of an encoder (such as when used as the feature generation processing unit 14a1, the intermediate representation generation model processing unit 14a2, the auxiliary input conversion processing unit 14a3, or the input data converter 14a7) or in a case of a decoder (such as when used as the entropy predictor 14a4 or the generation model processing unit 14b1), a general Linear layer may be used instead of a Causal Linear layer.

### Effects of Embodiment 4

Examples of effects obtained by the configuration and process of the neural network model described above will be described below. By reducing a size of data to be output (for example, a scale of the token dimension) in a stepwise manner by the Scale Down Block 53, it is possible to speed up the process of the layer and, by using a short-cut path, fine granularity of data is retained, and the process proceeds, thereby improving the accuracy of the neural network as a whole. Further, when the neural network is used as a decoder, in order to maintain a causal relationship with respect to a direction of the token dimension during the Up 546, in a case of a normal Linear, padding is required, which may cause leakage in a nearest receptive field and the accuracy is not efficiently improved. However, by introducing the number of groups into Scale Down Block 53 or Scale Up Block 54, and introducing the Causal Linear or the like, even when the token dimension is reduced in a stepwise manner by Down 536, a data element of the token dimension converted into the channel dimension by the Down 536 is made to correspond to the group of the channel dimension, so that the causal relationship of a fine unit is saved even after executing the Up 546, so leakage of the receptive field can be prevented, and the accuracy of the neural network can be efficiently improved as a whole in some cases.

The invention is not limited to the above-described embodiments, and includes various modifications. The embodiments described above have been described in detail to describe the invention in an easy-to-understand manner, and the invention is not necessarily limited to including all the described configurations. In addition, the configurations may not only be deleted, but also be replaced or added. Embodiments of the invention also include aspects in which a part or all of the above-described embodiments are appropriately combined to be consistent.

A part or all of the configurations, functions, processing units, processing methods, and the like described above may be implemented by hardware by, for example, designing with an integrated circuit. The invention can also be implemented by a program code of software for implementing the functions of the embodiments. In this case, a recording medium recording the program code is provided to a computer, and a processor provided in the computer reads the program code stored in the recording medium.

In this case, the program code read from the recording medium implements the functions of the embodiments described above by itself, and the program code itself and the recording medium storing the program code implement the invention. Examples of the recording medium for supplying such a program code include a flexible disk, a CD-ROM, a DVD-ROM, a hard disk, a solid state drive (SSD), an optical disk, a magneto-optical disk, a CD-R, a magnetic tape, a non-volatile memory card, and a ROM.

Further, a program code for implementing the functions described in the present embodiment can be implemented in a wide range of programs or script languages such as Python (registered trademark), Assembler, C/C++, Perl, Shell, PHP, and Java (registered trademark).

Control lines and information lines considered to be necessary for description are shown in the embodiments described above, and not all control lines and information lines are necessarily shown in a product. All the configurations may be connected.

What is claimed is:

1. An information processing method to be executed by an information processing system including a processor and a memory, the information processing method, by the processor, comprising:
receiving input data;
generating a feature of the input data;
acquiring retrieved data of the input data corresponding to the feature, based on correspondence relationship information between the feature and the retrieved data;
inputting the acquired retrieved data to a generation artificial intelligence (AI); and
acquiring answer data to the input from the generation AI.

2. The information processing method according to claim 1, wherein
the input data is a prompt to ask a question to the generation AI, and
the retrieved data is compressed data of auxiliary input data based on the input data.

3. The information processing method according to claim 2, wherein
the processor
generates intermediate representation data based on the prompt,
generates the feature based on the intermediate representation data,
converts the intermediate representation data into the auxiliary input data, and
generates the correspondence relationship information by associating the feature with the auxiliary input data.

4. The information processing method according to claim 3, wherein
the processor trains the auxiliary input data to generate a generation model that the generation AI has.

5. The information processing method according to claim 4, wherein
the processor
trains the auxiliary input data to generate an entropy predictor corresponding to the intermediate representation data,
uses the entropy predictor to compress the auxiliary input data, and
generates the correspondence relationship information by associating the feature with the compressed auxiliary input data.

6. The information processing method according to claim 3, wherein
the processor generates the feature and the intermediate representation data using a neural network model.

7. The information processing method according to claim 1, wherein
the input data is image data, and
the retrieved data is compressed data of intermediate representation data based on the image data.

8. The information processing method according to claim 7, wherein
the processor
generates a feature (compressed) that is a compressed feature based on the image data,
decompresses the feature (compressed) to generate the feature,
converts the feature into input conversion data,
generates the intermediate representation data based on the input conversion data, and
generates the correspondence relationship information by associating the feature (compressed) with the intermediate representation data.

9. The information processing method according to claim 8, wherein
the processor trains the intermediate representation data to generate a generation model that the generation AI has.

10. The information processing method according to claim 8, wherein
the processor
trains the feature to generate an entropy predictor corresponding to the feature,
uses the entropy predictor to decompress the feature (compressed) to generate the feature, and
uses the entropy predictor to compress the feature to generate the feature (compressed).

11. The information processing method according to claim 7, wherein
the processor generates the feature and the intermediate representation data using a neural network model.

12. The information processing method according to claim 11, wherein
the processor
acquires the intermediate representation data based on the correspondence relationship information if a size of the feature (compressed) is equal to or smaller than a predetermined value, and
generates the intermediate representation data using the neural network model if the size of the feature (compressed) is larger than the predetermined value.

13. An information processing system comprising:
a processor; and
a memory, wherein
the processor
receives input data,
generates a feature of the input data,
acquires retrieved data of the input data corresponding to the feature, based correspondence relationship information between the feature and the retrieved data,
inputs the acquired retrieved data to a generation artificial intelligence (AI), and
acquires answer data to the input data from the generation AI.

14. An information processing program causing a computer to execute processes of:
receiving input data;
generating a feature of the input data;
acquiring retrieved data of the input data corresponding to the feature, based on correspondence relationship information between the feature and the retrieved data;
inputting the acquired retrieved data to a generation artificial intelligence (AI); and
acquiring answer data to the input data from the generation AI.
